(19) United States
(12) Patent Application Publication
(10) Pub. No.: US 2007/0072157 A1
(43) Pub. Date: Mar. 29, 2007

(54) Methods for teaching and integrating athletics with academics

(76) Inventor: Sherman Vernon, Lompoc, CA (US)

Correspondence Address: Law Offices of Andrew Y. Schroeder, Suite 222, 500 S. Broadway, Santa Maria, CA, 93454, US

(21) Appl. No.: 11/224,834

(22) Filed: Sep. 12, 2005

(51) Int. Cl. G09B 19/00

(52) U.S. Cl. 434/247

(57) ABSTRACT

A method for teaching academics and athletics and integrating both athletics and academics comprising the following steps: (a) introducing a word of the day for use in teaching athletics and academics, said word of the day to be used throughout the day; (b) forming teams of students for use in competing in an athletic challenge and a academic challenge (c) awarding points to students and teams for positive results in both athletic challenges and academic challenges; (d) instructing students in academic subjects and integrating said word of the day for use in teaching athletics and academics; (e) executing athletic-academic challenges; said athletic-academic challenge comprising first a academic challenge to be followed by an athletic challenge; (f) teaching athletic skills to students while integrating said word of the day; teaching students how said word of the day relates to athletics; (g) executing sports games amongst said teams; (h) awarding said points to said teams which win their respective games.

### FIELD OF THE INVENTION

The present invention is in the area of education and pertains more particularly to methods of cross-instruction between athletics and academics.

### BACKGROUND OF THE INVENTION

Todays's schools and other educational institutions are not providing children with the skills and tools necessary to fully realize a child's potential. Many factors abound which contribute to our schools' inadequacies: lack of funding, lack of training, politics, incompetent teachers, and lack of creative strategies.

In particular, our schools fail to teach overarching themes, philosophies and ideas which are interdisciplinary in nature. For instance, in today's schools most subjects are taught in an ad hoc fashion: mathematics is completely compartmentalized from science, science is taught without relation to history, and history is given no context with respect to political science. Teachers almost never stress or point out patterns, similarities and correlations amongst the various subjects and disciplines. This lack of integration leaves children bored, confused, and poorly motivated to learn because they just do not see why studying is in their self-interest.

One fantastic opportunity to improve learning that our schools have overlooked is athletics. Most children and teenagers are naturally fascinated with sports. Many children can recite all the statistical metrics of their favorite athletes such as home runs, ERA, rushing yards, rebounds, points in a game, and such. Children acquire such information and knowledge upon their own free will. Unfortunately, schools have failed miserably to tap into this natural motivation for learning.

One thing schools can teach is how their favorite athletes perform the way they do. For instance, a quarterback must be able to recognize a particular defense, a baseball player must be able to recognize a particular pitch, or a basketball player must be able to recognize a pick. These patterns and skills are directly transferable to the classroom. For instance, in mathematics one must be able to recognize patterns, formulas, and such and how they correlate with each other. In history, students must be able to recognize patterns such as war, inflation, revolutions, dates and such. And in literature, one must be able to recognize various themes and motifs to fully appreciate the work.

Therefore, what is needed in the art is a method for integrating academics with athletics and motivating children to perform as well in the classroom as on the practice field by showing that the skill-sets are transferable. By motivating children in the classroom and showing children the similarities between academics and athletics children will be better equipped to compete elsewhere.

### SUMMARY OF THE INVENTION

A method for teaching academics and athletics and integrating both athletics and academics comprising the following steps:
(a) introducing a word of the day for use in teaching athletics and academics, said word of the day to be used throughout the day;
(b) forming teams of students for use in competing in an athletic challenge and a academic challenge
(c) awarding points to students and teams for positive results in both athletic challenges and academic challenges;
(d) instructing students in academic subjects and integrating said word of the day for use in teaching athletics and academics;
(e) executing athletic-academic challenges; said athletic-academic challenge comprising first a academic challenge to be followed by an athletic challenge;
(f) teaching, identifying, and refining abilities into skills;
(g) teaching athletic skills to students while integrating said word of the day; teaching students how said word of the day relates to home, social, academic arenas and other attendant situations
(h) executing sports games amongst said teams;
(i) awarding said points to said teams which win their respective games.

In some preferred embodiments, the method further comprising the step of 1. lecturing students on correlation between athletics and academics, 2. asking students how said word of the day relates to athletic skills, home, social, academic arenas and other attendant situations 3. awarding prizes to students who earn said points, 4. awarding prizes to said teams who win their respective games.

Said method comprises academic subjects such as reading, writing and mathematics. Said method comprises sports games such as football, basketball, soccer, baseball, and others. Said method also includes the step of teaching students how athletics-related skills are similar to academic-related skills, and how academic-related skills are related with athletics. Said method further comprising the step of teaching students how athletic-related skills can be used in home, social, academic, or other occupational situations.

In some preferred embodiments, said method further comprises awarding students who display exemplary conduct. In other preferred embodiments, said method further comprises the step of quizzing students on how said word of the day helped them perform in said sports games amongst said teams. In other preferred embodiments said method further comprises the step of stretching the students and warming up the students with exercises. In other preferred embodiments, said method further comprises the step of executing a closing session; said closing session consisting of summing up said points earned by said teams and students and reviewing said word of the day.

In some preferred embodiments, said method further comprises the step of awarding a point for excellent academic work for that day. In other preferred embodiments, said method further comprises the step of awarding a point for excellent athletics work for that day.

### BRIEF DESCRIPTION OF THE DRAWING FIGURES

FIG. 1 is a flow diagram of a preferred embodiment of the present invention.

FIG. 2 is a block diagram of a preferred embodiment of the present invention.

### DESCRIPTION OF PREFERRED EMBODIMENTS

According to a preferred embodiment of the present invention, a unique method is used to teach children both academics and athletics and fully integrating both academics and athletics in such a way to make learning fun and meaningful to children. The present invention is described in enabling detail below.

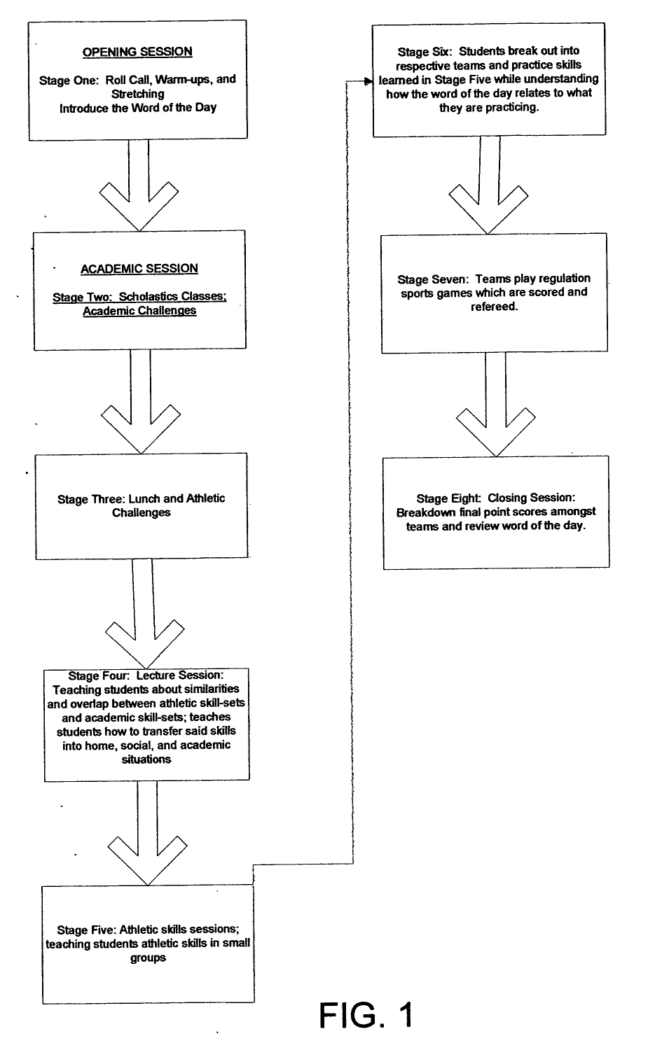

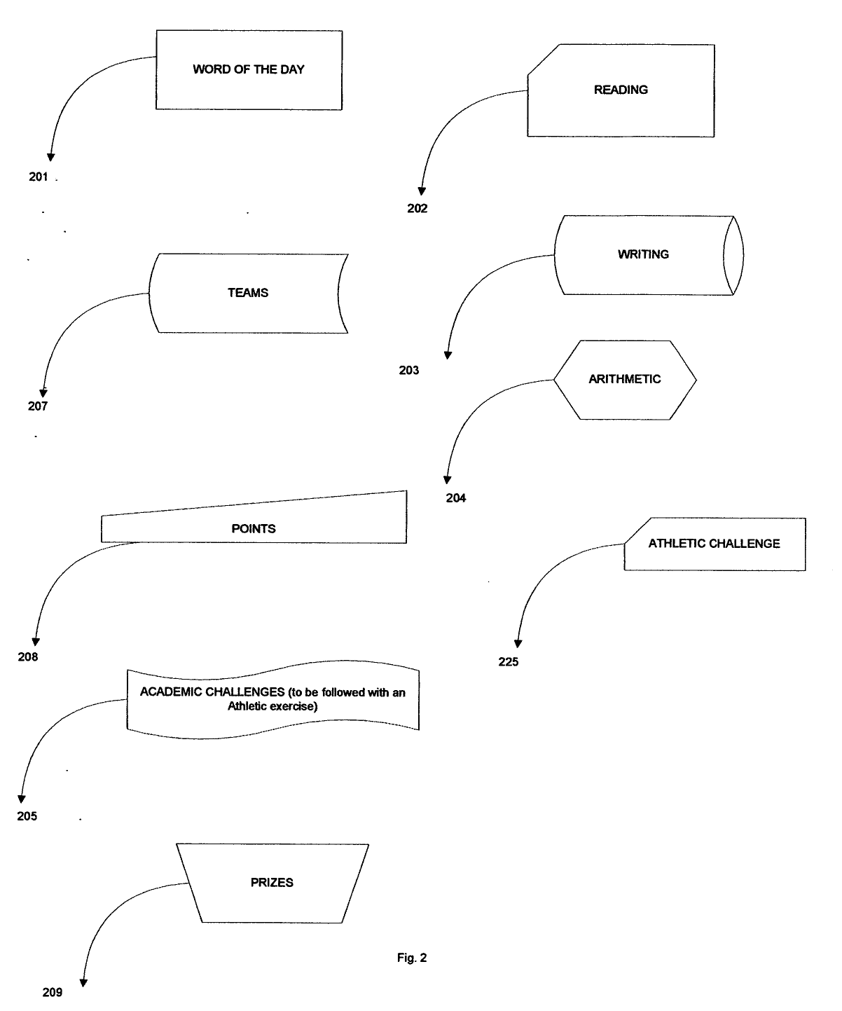

FIG. 1 is a flow diagram which illustrates a preferred embodiment of the present invention. Stage one 101 is the beginning of the training camp. Stage one 101 consists of meeting and greeting amongst teachers, coaches, and students which is followed up by roll call. Most importantly, the word of the day 201 is introduced. FIG. 2 is a block diagram of some of the key components of the present invention.

The word of the day 201 is one of the most critical elements of the present invention. The word of the day 201 is used to integrate both the athletic training as well as the academic training as well. By way of example, suppose the word of the day is “Recognize”. “Recognize” will be used to illustrate to children that this ability or skill is readily adaptable to both academics as well as athletics. By way of example, children may learn that in football, a quarterback must be able to “recognize” whether the defense is playing man to man or zone. A basketball player must discern whether the offensive side is trying to set up a pick or a screen and how to make the necessary adjustments. Or a baseball player must recognize a particular pitch from a pitcher's hand whether it is a fastball, changeup, slider, or curveball. And in academics, a mathematician must recognize various patterns in algorithms or a historian must recognize various patterns such as inflation, war, dates, economics, etc.

In addition to the word of the day 201, there may also be an acronym for the week 222. The acronym of the week may encompass all of the words of the week. An example may be CAAN. CAAN may stand for conceive, analyze, annotate, and negotiate. Each of these constituent words may be the word of the day 201 for that particular day.

Throughout the day, the word of the day 201 is inculcated to the children repeatedly. For instance, later in the day if the children are playing football a coach will repeatedly ask the child how the word of the day 201 relates to what they are doing on a practice field. If a child is playing linebacker and immediately sees a couple guards pull out and run into the flat, the child will recognize that the offense is running a screen play. After the play, a coach will ask the linebacker how he knew the offense was executing a passing play. Child will then respond that he recognized that the offense was running a screen play because the guards were running into the flat.

Another critical component in the present invention is the formation of teams 207. At the beginning of training camp, children are grouped into various teams which compete against each other. Teams 207 compete against each other for points 208. Points 208 may be awarded during both academic challenges as well as athletic challenges. Points 208 may also be awarded for pop quizzes and exemplary conduct. For example, if a child performs Points 208 are also awarded in the afternoon to the winning team in the afternoon games whether it be football, basketball, baseball, soccer or any other sport. At the end of the day, the team 207 with the most points will win prizes 209. Prizes 209 may be T-shirts, food, gift certificates, etc.

Points 208 are also awarded by both the teachers and coaches for outstanding work each day. Each day the academic teachers will nominate one child who displays an excellent performance for that particular day. Likewise, the coaches will nominate one student/player for excellent performance for that particular day. By being nominated, that child will earn points for his or her team.

Another component of the present invention is to identify various athletic abilities and refine those abilities into skills. Skills such as dribbling, vision, agility, leadership, and calling plays are identified and are refined. Students are taught that raw potential must be further refined through training, repetition, and hard work. And after the child has acquired a skill, the child is shown how to apply that skill to either the classroom, home, social life and other arenas. This component is usually taught during the afternoon athletic portion of the day.

Throughout the camp students are taught to take ownership and pride in their skills and abilities, and how those skills and abilities are immediately transferable to other areas of their life. For instance, if a child shows a talent, skill, and ability for running the floor in a basketball game, the student is shown that he or she possesses the skills of multi-tasking, conflict resolution, and leadership. By running the floor in a basketball game, the child shows that he or she can dribble, call out a play, discern the defense, and ignore the crowd. Also, by running the floor, the child shows that he or she can command the attention and respect of his or her team mates by controlling the play. He or she also might exhibit conflict resolution skills by defusing inevitable conflicts associated with team sports. Child is then shown that this ability to multi-task is useful in the corporate world where a CEO must juggle writing a memorandum, instruct the secretary, and signing off on a board directive nearly simultaneously. The purpose of this exercise is to excite the students about using their newfound abilities. Students are no longer taking notes in a classroom, they are exercising their “multi-tasking and information processing” skills.

Stage two 102 is when the children go to academic classes such as reading 202, writing 203 and arithmetic 204. At the beginning of each lecture the teacher will introduce the word of the day. And all of the academic exercises will be related to the word of the day. If the word of the day 201 is “analyze”, the child may have to analyze a mathematical equation or formula. The child will be taught how to analyze the mathematical equation or formula and will thereafter perform practice exercises in analysis.

During Stage two 102 children perform academic challenges 205. Academic challenges 205 are typically performed in a classroom. Academic challenges 205 are comprised of two components: one academic challenge and an athletic exercise. A typical challenge may consist of a child first being asked to solve a mathematical equation. And if the child successfully passes the academic challenge, child may move on to the athletic exercise. If child does not pass the academic challenge, he or she may not advance to the athletic exercise. The athletic exercise may consist of throwing sponge basketballs into a hoop. If child passes academic challenge, child will earn points 208. And irregardless of whether child is able to successfully perform the athletic exercise, child will also be awarded points. However, child will be awarded extra points for successfully completing the athletic exercise. For this reason, said academic challenges 205 bring to bear maximum and minimum numbers of points 208.

Stage three 103 is generally around noon where children have lunch and compete in athletic challenges where they can accumulate more points 208.

Stage four 104 is a lecture session. Lecture session generally calls for a guest speaker to speak about the similarities and transferable abilities and skill sets between both athletics and academics. In order to intelligently speak on this topic, speaker typically has a successful athletic background as well as a successful academic background and attendant successful career.

In stage four 104 speaker generally speaks about how the lessons he or she learned on the practice field helped him or her excel in his or her academic career and vice versa. For instance, a speaker might talk about how preparing for a wrestling tournament was similar to preparing for an exam in graduate school. Or, speaker might talk about how studying for a trigonometry exam was similar to watching game film on an upcoming pitcher in collegiate baseball. Speaker will also speak generally how he or she has been able to parlay an athletic scholarship into a successful career in optometry. The general idea of lecture session is to stress the inherent self interest of children to study hard and play hard to bring them a better future.

In stage five 105 children undergo a group skill session which is primarily athletic in nature. For instance, one group skill session might be how to execute a jump shot. Another group skill session might be how to steal a base. Students are taught the nuances of these skills along with the concomitant word of the day. An example might be that if the word of the day is “Recognize” and the skill is stealing a base, a student might be quizzed on how “Recognize” enables them to know when is the optimum time to break for second base.

One theme that should be pointed out here is the idea of “showing your work”. The training camp will require all children to articulate all of the steps of how they arrive at their analysis, conclusion or answer or athletic play. For example, an algebraic problem performed in said academic challenge above would require the child to show clearly on the chalkboard all the steps he or she executed to arrive at his or her answer. And if a child is asked why she decided to go for a jump shot, he or she will not be able to say “because I wasn't covered”. She would be required to articulate all of the steps and thinking process behind the play. For instance, a correct answer might be: “I recognized that Tony and Angie were being covered, I recognized the zone defense, I was not being covered, and therefore I took the jump shot”. Or in baseball a child might be asked why he or she swung on a 3-0pitch with a base-runner on third. Child would not be able to say “because I wanted to drive in Tony from third”. Child would be required to analyze in the following manner: “I recognized that Anthony could not throw a breaking ball for a strike on the first three pitches. I knew Anthony did not want to walk me with a tied ball game. I recognized that Anthony would have to throw a fastball down the middle of the plate. I knew I could pull Anthony's fastball to right field where Lisa does not have a strong throwing arm. I knew that with only one out I could drive the ball deep enough so that even if Lisa did catch the ball Tony would be able to make it to home plate before Lisa's cutoff throw.”

Another example may be with basketball. A defender must be able to recognize whether the offense is running a pick or a screen play and make the appropriate adjustments. When a defender recognizes a pick, he knows he will not have any help. Therefore, defender must step over the top of the pick in order to defend. Whereas, in a screen, defender knows that he does have help and he must step through the screen to successfully defend the play. There are other times when recognizing picks and screens are important for defensive play. In some instances, the type of play will dictate which hand to dribble with for optimum performance.

In stage six 106 the children will break out into their respective teams. During stage six 106 the teams will practice the skills they just learned in stage five 105. Again, during this period the children will be quizzed on the word of the day and how it relates with the particular skill which they are practicing.

In stage seven 107, the teams compete against each other which is being refereed and scored as a regulation game. Referees are typically used along with regulation clocks. The sport they compete in could be any team sport or any individual sport. Just about any sport may be used such as soccer, football, basketball, baseball, lacrosse, wrestling, etc. The possibilities here are endless.

After the games are scored, in stage eight 108 the children and coaches gather together for a closing session. This closing session serves the purpose of giving the points breakdowns of the children and the teams. The closing session also serves the purpose of going over what has been learned that day. The word of the day is explained once again and summarized.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A method for teaching academics and athletics comprising the following steps:
(a) introducing a theme of the day
(b) awarding points to students
(c) integrating theme of the day into academic and athletic training
(d) executing athletic and/or academic challenges throughout the day

2. A method for teaching academics and athletics and integrating both athletics and academics comprising the following steps:
(a) introducing a word of the day for use in teaching athletics and academics, said word of the day to be used throughout the day;
(b) forming teams of students for use in competing in an athletic challenge and an academic challenge
(c) awarding points to students and teams for positive results in both athletic challenges and academic challenges;
(d) instructing students in academic subjects and integrating said word of the day for use in teaching athletics and academics;
(e) executing athletic-academic challenges; said athletic-academic challenge comprising first an academic challenge to be followed by an athletic challenge;
(f) teaching athletic skills to students while integrating said word of the day; teaching students how said word of the day relates to athletics;
(g) executing sports games amongst said teams;
(h) awarding said points to said teams which win their respective games.

3. The method of claim 2 further comprising the step of lecturing students on correlation between athletics and academics.

4. The method of claim 2 further comprising the step of asking students how said word of the day relates to athletic skills.

5. The method of claim 2 further comprising the step of asking students how said word of the day relates to academics.

6. The method of claim 2 further comprising the step of awarding prizes to students who earn said points.

7. The method of claim 2 further comprising the step of awarding prizes to said teams who win their respective games.

8. The method of claim 2 wherein said academic subject is mathematics.

9. The method of claim 2 wherein said academic subject is related with reading.

10. The method of claim 2 wherein said academic subject is related to writing.

11. The method of claim 2 wherein said sports game is basketball.

12. The method of claim 2 wherein said sports game is baseball.

13. The method of claim 2 wherein said sports game is a sport selected from the group consisting of: soccer, football, basketball, baseball, water polo, track and field, boxing, tennis, swimming, baseball, volleyball, cheerleading, wrestling, martial arts, bowling, archery, table tennis, softball, hockey, equestrian-related sports, golf, lacrosse, cycling, gymnastics, weightlifting, skating, curling, shooting, rowing, sailing, canoeing, kayaking, badminton, aquatic-related sports, and skiing.

14. The method of claim 2 further comprising teaching students how athletics-related skills are similar to academic-related skills, and how academic related skills are related with athletics.

15. The method of claim 2 further comprising teaching students how athletic related skills can be used in home, social, academic, and occupational situations.

16. The method of claim 2 further comprising awarding students who display exemplary conduct.

17. The method of claim 2 further comprising the step of quizzing students on how said word of the day helped them perform in said sports games amongst said teams.

18. The method of claim 1 further comprising the step of stretching the students and warming up the students with exercises.

19. The method of claim 2 further comprising the step of executing a closing session; said closing session consisting of summing up said points earned by said teams and students and reviewing said word of the day.

20. The method of claim 2 further comprising the step of awarding a point for excellent academic and athletic works for that day.
